(19) United States
(12) Patent Application Publication
(10) Pub. No.: US 2018/0078338 A1
(43) Pub. Date: Mar. 22, 2018

(54) SYSTEMS AND METHODS FOR ACCELERATED TOOTH MOVEMENT IN ALIGNER TREATMENT

(71) Applicant: Advanced Orthodontics and Education Association, LLC, Ossining, NY (US)

(72) Inventors: Bryce A. WAY, San Jose, CA (US); Richard JOHNSON, Briarcliff Manor, NY (US)

(73) Assignee: ADVANCED ORTHODONTICS AND EDUCATION ASSOCIATION, LLC.

(21) Appl. No.: 15/672,730

(22) Filed: Aug. 9, 2017

Related U.S. Application Data
(63) Continuation-in-part of application No. PCT/US2017/019767, filed on Feb. 27, 2017.
(60) Provisional application No. 62/300,705, filed on Feb. 26, 2016.

(51) Int. Cl. A61C 7/00; A61C 7/08

(52) U.S. Cl. CPC A61C 7/008; A61C 7/08

(57) ABSTRACT

Embodiments of the present disclosure are directed to devices and methods for accelerating tooth movement during dear aligner treatment with vibration. According to various implementations, a vibrational dental device configured to vibrate at a frequency of about 120 Hz may be obtained. Subjects undergoing clear aligner treatment may be treated for less than about twenty minutes daily with the exemplary vibrational dental device. The duration of clear aligner treatment and the rate between changing aligners may be significantly decreased by the vibration, while tracking quality may be maintained.

### BACKGROUND

### Technical Field

The present disclosure generally relates to dental devices and methods. More particularly, and without limitation, the disclosed embodiments relate to devices, systems, and methods for accelerating tooth movement during aligner treatment with vibration.

### Background Description

Clear aligner treatment is a common option for many adults and teens who wish to avoid the impracticality and unsightliness of fixed appliances such as braces but who also still desire to improve their occlusion and smile. Clear aligner treatment includes use of a plurality of clear plastic aligners to slowly move each tooth into the desired alignment. While this approach significantly improves quality of care for many patients, it has some limitations which may prevent some patients from accepting this treatment modality. One common concern is the requirement for over 20 hours of wear per day, with restrictions on eating and drinking. Considering that this daily wear requirement needs to be maintained during the entire treatment duration, the length of treatment becomes a critical decision factor for prospective patients.

Usually, aligners are shaped according to a patient-specific treatment plan for the movement of the patient's teeth into the desired alignment. The length of treatment is controlled by how fast the patient progresses from one aligner to the next. The typical treatment plan is configured so that the patient changes their aligners every two weeks. As part of a patient-specific treatment plan, a computer model is often generated to predict a trajectory of how the teeth will move as a result of the aligners. “Tracking” refers to movement of the teeth according to the treatment plan. “Non-tracking” refers to differences in actual teeth movement, such as lagging movement, as compared to the prediction. Non-tracking can occur, for example, when a patient neglects to wear their aligners every day or for the required daily time. One main consequence of non-tracking is that a patient may be unable to progress from one aligner to the next, due to ill fit and pain.

There is interest in the field of orthodontics in finding ways to accelerate treatment time during orthodontic treatment. For aligner treatment, some have considered accelerating treatment by changing aligners more frequently. However, clinicians do not recommend aligner change intervals of less than two weeks because shorter intervals may cause non-tracking and prevent progression from one aligner to the next. This poor performance may be related to inefficient force delivery by ill-fitting aligners, and to limited biological response. Steps have been taken to improve force delivery by aligners, such as the use of Smartrack™ plastic in aligners. However, the rate of tooth movement, and therefore progression between aligners, remains limited by a patient's biological response. For example, prior efforts to change aligners more frequently often include applying larger forces with each aligner. However, it has been found that teeth reach a “saturation point” of sorts, in which rate of movement will not increase beyond a certain force magnitude. As a consequence, these efforts often result in decreased tooth movement and poor tracking. Conversely, while decreasing the magnitude of tooth movement per aligner may allow better tracking along with a decreased interval between aligners, this would hugely increase the number of aligners, and thus the associated cost of treatment, without decreasing the overall treatment time. Further, in some cases, acceleration of tooth movement has been associated with increased root resorption, in which the root structure breaks down and is eventually destroyed by living body cells.

Other efforts to accelerate tooth movement during orthodontic treatment have included application of low-frequency vibration to the teeth while the teeth are being treated with an orthodontic appliance. Woodhouse, N. R. et al. (“Supplemental Vibrational Force During Orthodontic Alignment: A Randomized Trial”), Journal of Dental Research 94(5): 682-689 (2015), which is incorporated by reference herein, investigated the effects of low frequency vibration on the rate of tooth movement in patients with fixed appliances (i.e., braces). Subjects with fixed appliances were treated with the commercially available dental device AcceleDent™, developed by OrthoAccel® Technologies, Inc., which provides a vibrational frequency of 30 Hz and a force of 0.2 N to the teeth being treated with the fixed appliances. Subjects were treated with AcceleDent™ daily for 20 minutes per day until the teeth reached final alignment, and were compared with controls with fixed appliances who had not been treated with AcceleDent™. Woodhouse found no evidence that 30 Hz treatment with AcceleDent™ significantly increased the rate of tooth movement or reduced the amount of time required for the teeth to achieve final alignment, when used in conjunction with fixed appliances.

Thus, there remains a continued need for an effective technique to accelerate tooth movement during orthodontic treatment, such as during aligner treatment, while maintaining quality tracking to achieve the desired tooth alignment. Such a technique may reduce the time needed for orthodontic treatment, thus minimizing cost and inconvenience for the patient and increasing the likelihood of patient compliance. Additionally, such a technique may achieve the same quality alignment provided by non-accelerated orthodontic devices, since tracking quality is maintained.

### SUMMARY

The embodiments of the present disclosure include devices, systems, and methods for accelerating tooth movement in aligner treatment with high-frequency vibration. Advantageously, the exemplary embodiments provide a method of accelerating tooth movement while maintaining tracking.

According to an exemplary embodiment of the present disclosure, a method for accelerating an orthodontic treatment which includes a plurality of aligners is described. The method includes obtaining the aligners, obtaining an orthodontic movement acceleration device, and treating the teeth. The aligners are configured to be worn in the mouth of a patient in a pre-determined sequence to move the patient's teeth substantially into a desired alignment. The aligners can be programmed for movement over any clinically meaningful distance, stepwise with each aligner change. The exact distance moved is usually determined by software, with an example being 0.25 mm of anterior-posterior movement on a target incisor. The orthodontic movement acceleration device includes a mouthpiece and a vibration source coupled to the mouthpiece and configured to vibrate at a frequency of about 120 Hz. Treating the teeth includes treating the teeth with each aligner in the pre-determined sequence. For each aligner, treatment includes placing the mouthpiece within the mouth of the patient while the patient is wearing the aligner, and activating the vibration source for less than twenty minutes daily while the aligner contacts the mouthpiece For example the time period can be, for example, less than about 20 minutes, 15 minutes, 10 minutes, 6 minutes, 5 minutes, 4 minutes, or less. It is contemplated that, in other embodiments the time period could be any value within the range of about 1 minute and 19 minutes daily, and that the daily total treatment time could be formed of a plurality of treatment sessions contributing to the daily total treatment time. In one exemplary embodiment, the daily total treatment time is about 5 minutes. The activation of the vibration source accelerates movement of the teeth substantially into the desired alignment.

According to another exemplary embodiment of the present disclosure, a method for accelerating an orthodontic treatment which includes a plurality of aligners is described. The method includes obtaining the aligners, obtaining an orthodontic movement acceleration device, and treating the teeth. The aligners are configured to be worn in the mouth of a patient in a pre-determined sequence to move the patient's teeth substantially into a desired alignment. The orthodontic movement acceleration device includes a mouthpiece and a vibration source coupled to the mouthpiece and configured to vibrate at an acceleration magnitude ranging between about 0.03 G and about 0.2 G. Treating the teeth includes treating the teeth with each aligner in the pre-determined sequence. For each aligner, treatment includes placing the mouthpiece within the mouth of the patient while the patient is wearing the aligner, and activating the vibration source for about five minutes daily while the aligner contacts the mouthpiece. The activation of the vibration source accelerates movement of the teeth substantially into the desired alignment.

According to a further exemplary embodiment of the present disclosure, a method for accelerating orthodontic treatment by minimizing a treatment duration associated with at least one aligner in a plurality of aligners is described. The aligners are configured to be worn in the mouth of a patient in a pre-determined sequence to move the patient's teeth substantially into a desired alignment. The method includes treating the teeth with the aligners in the pre-determined sequence and, for at least one aligner, accelerating teeth movement. Treating the teeth includes treating the teeth with each aligner for a treatment duration. Accelerating teeth movement includes applying vibration to the aligner for about five minutes daily with a vibration device while the patient is wearing the aligner. The vibration device can be configured to vibrate with a frequency of about 120 Hz. The vibration accelerates teeth movement such that the treatment duration for the at least one aligner is 7 days or fewer.

According to a still further exemplary embodiment of the present disclosure, a method for accelerating orthodontic treatment by minimizing a treatment duration associated with at least one aligner in a plurality of aligners is described. The aligners are configured to be worn in the mouth of a patient in a pre-determined sequence to move the patient's teeth substantially into a desired alignment. The method includes treating the teeth with the aligners in the pre-determined sequence and, for at least one aligner, accelerating teeth movement. Treating the teeth includes treating the teeth with each aligner for a treatment duration. Accelerating teeth movement includes applying vibration to the aligner for about five minutes daily with a vibration device while the patient is wearing the aligner. The vibration device is configured to vibrate at an acceleration magnitude ranging between about 0.03 G and about 0.2 G. The vibration accelerates teeth movement such that the treatment duration for the at least one aligner is 7 days or fewer

According to another exemplary embodiment of the present disclosure, a method for improving the fit of at least one aligner for orthodontic treatment is described. The method includes obtaining a number of aligners, and treating the teeth with the aligners. The aligners are configured to be worn in the mouth of a patient in a pre-determined sequence. The aligners are fabricated according to a treatment plan for the patient to move the patient's teeth substantially into a desired alignment. Treating the teeth includes treating the teeth with the aligners in the pre-determined sequence and, for at least one aligner, improving the fit thereof. Improving the fit includes applying vibration to the aligner for about five minutes daily with a vibration device while the patient is wearing the aligner. The vibration device is configured to vibrate with a frequency of about 120 Hz. The vibration improves the fit of the at least one aligner upon the teeth such that movement of the teeth due to the aligner is accelerated.

According to another exemplary embodiment of the present disclosure, a method for improving the fit of at least one aligner for orthodontic treatment is described. The method includes obtaining a number of aligners, and treating the teeth with the aligners. The aligners are configured to be worn in the mouth of a patient in a pre-determined sequence. The aligners are fabricated according to a treatment plan for the patient to move the patient's teeth substantially into a desired alignment. Treating the teeth includes treating the teeth with the aligners in the pre-determined sequence and, for at least one aligner, improving the fit thereof. Improving the fit includes applying vibration to the aligner for about five minutes daily with a vibration device while the patient is wearing the aligner. The vibration device is configured to vibrate at an acceleration magnitude ranging between about 0.03 G and about 0.2 G. The vibration improves the fit of the at least one aligner upon the teeth such that movement of the teeth due to the aligner is accelerated.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed. The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1A is a perspective view of an exemplary vibrational dental device, according to embodiments of the present disclosure.

FIG. 1B is a partial perspective view of the exemplary vibrational dental device of FIG. 1A, according to embodiments of the present disclosure.

FIG. 1C is a partial component view of the exemplary vibrational dental device of FIG. 1A, according to embodiments of the present disclosure.

FIG. 2 illustrates an operation of the exemplary vibrational dental device of FIG. 1.

FIG. 3A illustrates an average number of aligners prescribed and an average number of aligners actually used in an experimental group treated with vibration and in a control group, according to Example 1 of the present disclosure.

FIG. 3B illustrates average estimated and actual treatment durations for the vibration and control group subjects, according to Example 1 of the present disclosure.

FIG. 3C depicts a number of refinements required for the vibration and control groups, according to Example 1 of the present disclosure.

FIG. 4 illustrates an intraoral scan taken from a subject at the end of clear aligner treatment to evaluate tracking, according to Example 2 of the present disclosure.

FIGS. 5A-5P each show the measurement of vibration of an exemplary typodont subject to vibration treatment by the exemplary vibrational dental device of FIG. 1 under different testing conditions, according to Example 3 of the present disclosure.

FIGS. 6A-6P each show the measurement of vibration of an exemplary typodont subject to vibration treatment by a commercially available dental device under different testing conditions, according to Example 3 of the present disclosure.

FIG. 7A graphically compares g-force measurements of a typodont with an aligner subject to vibration treatment by the exemplary vibrational dental device of FIG. 1 and an exemplary commercially available dental device, according to Example 3 of the present disclosure.

FIG. 7B graphically compares g-force measurements of a typodont without an aligner subject to vibration treatment by the exemplary vibrational dental device of FIG. 1 and an exemplary commercially available dental device, according to Example 3 of the present disclosure.

FIG. 8 summarizes the results of Example 3.

FIG. 9 illustrates measured tooth movement between the beginning and completion of clear aligner treatment for a control group, a group treated with an exemplary commercially available dental device, and a group treated with the exemplary vibrational dental device of FIG. 1, according to Example 4 of the present disclosure.

### DETAILED DESCRIPTION

Exemplary embodiments are described with reference to the accompanying drawings. In the figures, which are not necessarily drawn to scale, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise. Additionally, it should be noted that as used herein and in the appended claims, the term “plurality” refers to any number greater than one (for example, a plurality of aligners is any number of aligners greater than a single aligner).

Prior attempts to accelerate orthodontic treatment with vibration have been unsuccessful. For example, studies have shown that treatment of the teeth with 30 Hz micro-vibrations using an AcceleDent™ device does not accelerate tooth movement during orthodontic treatment, nor does it reduce treatment time. One possible explanation for this failure may be the low frequency of the vibration which is delivered by AcceleDent™. Lala, A. (“Vibration therapy in orthodontics: Realising the benefits”), International Magazine of Orthodontology, No. 1: 24-27 (2016), which is incorporated by reference herein, cites several studies (including Woodhouse) which fail to establish a tooth movement acceleration benefit from AcceleDent™, and suggests that the low 30 Hz frequency may be a contributing factor to AcceleDent™'s ineffectiveness. Lala further notes a study by Alikhani et al. (“Osteogenic Effect of High-frequency Acceleration on Alveolar Bone”), Journal of Dental Research, 91(4): 413-419 (2012), which is incorporated by reference herein, which found that bone formation rates in rats were significantly higher when treated with high frequency vibration (e.g. 90 Hz or higher) as compared to low frequency vibration (e.g. 45 Hz or lower). Therefore, it is hypothesized here that application of higher frequency vibration may accelerate teeth movement during orthodontic treatment, since teeth movement rates may be associated with rates of bone formation and remodeling. However, as Lala notes, previously no system existed which was capable of applying high frequency vibration to the human dentition to provide such benefits.

The disclosed embodiments relate to devices, systems, and methods for accelerating tooth movement during aligner treatment using vibration. Advantageously, embodiments of the present disclosure can accelerate tooth movement and reduce treatment time while maintaining quality tracking.

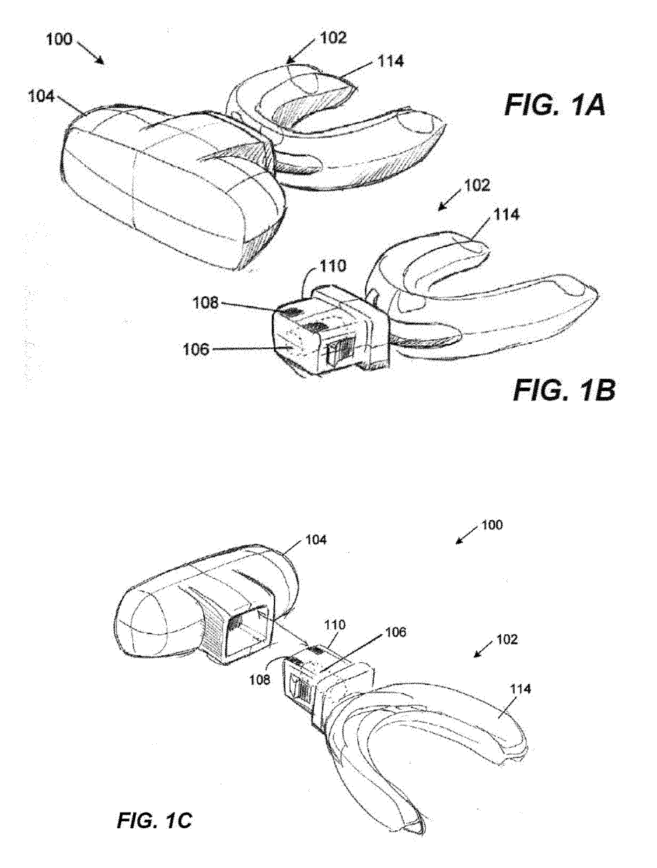

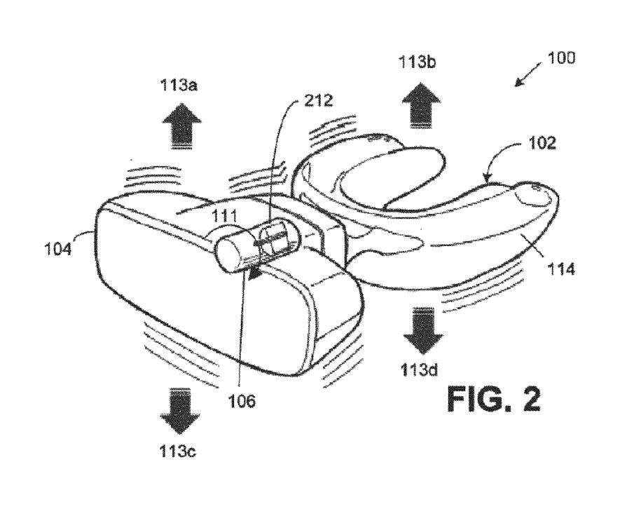

FIG. 1A is a perspective view of an exemplary vibrational dental device 100. FIG. 1B is a partial perspective view of vibrational dental device 100. FIG. 1C is a partial component view of vibrational dental device 100. As shown in FIGS. 1A-1C, vibrational dental device 100 includes a mouthpiece 102, a base 104, and a motor 106. Mouthpiece 102 is removably attached to base 104. Mouthpiece 102 includes a biteplate 114 and a mouthpiece extension 110 configured to connect with base 104. In some embodiments, mouthpiece 102 and/or biteplate 114 can be configured to engage some or all of a user's teeth. For example, in the exemplary embodiments shown in FIGS. 1A-2, mouthpiece 102 and/or biteplate 114 are shaped to engage some or all of a user's teeth. As described herein, the shape of mouthpiece 102 and/or biteplate 114 shown in FIGS. 1A-2 is only exemplary. Mouthpiece 102 and/or biteplate 114 may have a U-shape or a C-shape as depicted, or a customized shape suitable for safe application of vibrational treatment to all or some of a user's teeth. The mouthpiece can be made to apply vibration directly to a user's teeth, or to aligners or other appliances applied to the teeth. Extension 110 may further include contacts 108 that electrically connect base 104 with motor 106.

As shown in FIGS. 1B and 1C, motor 106 is installed in extension 110 of mouthpiece 102. When mouthpiece 102 is attached to base 104, motor 106 resides in base 104. Base 104 further includes electronic circuitries (not shown), including a control circuitry and a power circuitry, for operating motor 106. Motor 106 may be any type of motor that can cause mouthpiece 102 or biteplate 114 to vibrate. For example, motor 106 could be a vibration motor, piezoelectric motor, a linear motor, or an electromagnetic motor. The frequency and/or strength of vibration caused by motor 106 can be adjusted by changing the voltage or current supplied to motor 106 by the electronic circuitries in base 104. For example, the voltage used for operating motor 106 may range from about 0.5 volt to about 4 volts. The current supplied to an exemplary motor 106 may range from about 65 mA to about 100 mA.

Motor 106 may have any suitable mechanical configurations to cause mouthpiece 102 or biteplate 114 to vibrate axially. FIG. 2 illustrates an exemplary operation of vibrational dental device 100. As shown in FIG. 2, in one embodiment, motor 106 is a counter-weighted motor with a longitudinal axis parallel to the longitudinal axis of extension 110. Motor 106 may include a counterweight 212 that is off-axis from the longitudinal axis of motor 106. When the motor 106 rotates, as shown by the arrow 111 in FIG. 2, counterweight 212 moves up and down, causing the mouthpiece 102 to vibrate up and down, as shown by the arrows 113a-113d in FIG. 2. Accordingly, when the exemplary mouthpiece 102 is placed between a user's teeth, and when exemplary vibrational dental device 100 is turned on, the vibration of mouthpiece 102 will apply an axial vibratory force on the occlusal surfaces of the teeth. For example, biteplate 114 of mouthpiece 102 may cyclically rove axially between the occlusal surfaces of the teeth.

In some embodiments, vibrational dental device 100 may further include one or more sensors (not shown), such as piezoelectric sensors, configured to detect the acceleration magnitude and/or frequency of the vibration of mouthpiece 102. For example, sensors may be placed on the outside or the inside edge of biteplate 114, proximate to the occlusal surfaces of the teeth when mouthpiece 102 is clamped between the occlusal surfaces. The sensors can be electrically connected to the electronic circuitries in base 104. Measurements of the sensors can be fed beak to the control circuitry of motor 106 to adjust the acceleration magnitude and/or frequency of motor 106. For example, the detected acceleration magnitude and/or frequency may be compared to a desired acceleration magnitude and/or frequency, and the voltage and/or current supplied to motor 106 can be adjusted based on the comparison.

In some embodiments, motor 105 is configured to vibrate mouthpiece 102 at a frequency higher than 80 Hz, such as at a frequency between about 100 Hz to about 140 Hz, and more specifically at a frequency at or about 120 Hz. Motor 106 may be further configured to vibrate mouthpiece 102 at an acceleration magnitude ranging between about 0.03 G and about 0.2 G. As described herein, the vibrational frequency of mouthpiece 120 may vary from the rated “free-air” vibrational frequency of motor 106 due to the amount of biting force or load applied to mouthpiece 102, such as the force used to clamp vibrational dental device 100 in place. For example, when motor 106 is configured to vibrate at a frequency of or about 120 Hz, adding biting force or load to mouthpiece 102 may result in a lower vibrational frequency of mouthpiece 102 ranging from about 100 Hz to about 120 Hz.

Examples 1-4 described below illustrate the use of vibrational dental device 100 operating under these variables and its clinically relevant effects.

### EXAMPLE 1

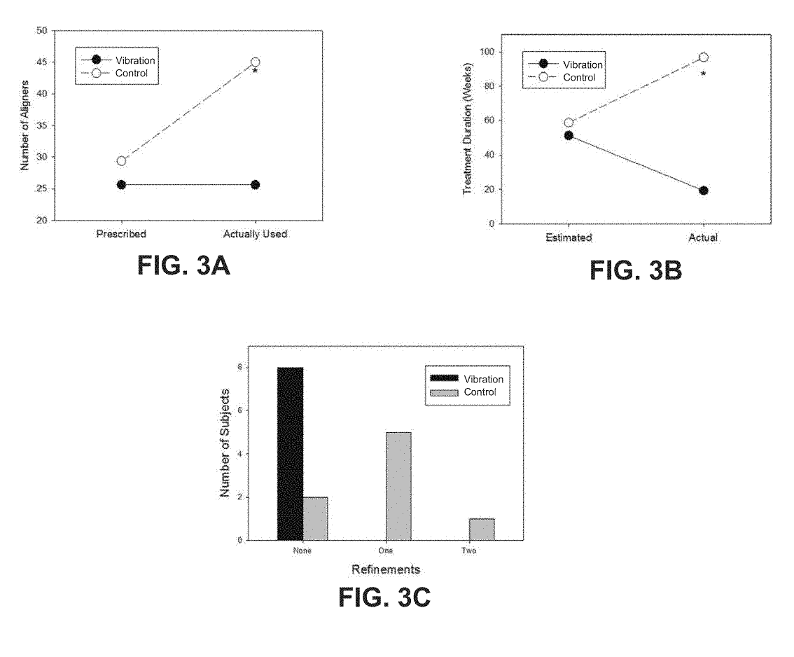

A retrospective, observational clinical study was conducted to investigate both the rate of clear aligner exchange and the time required to complete treatment among subjects that received clear aligner treatment, with and without vibration treatment by an exemplary device 100. The study evaluated eight subjects who received aligner treatment in conjunction with vibration, and eight control subjects who received aligner treatment without vibration. All subjects had Class I skeletal malocclusions, and mild to moderate crowding (i.e. 3 mm-5 mm). All subjects were treated with a plurality of Smartrack™ aligners, each having the default prescription level for tooth movement distance, until treatment was completed (that is, upper and lower crowding were at 0.0 mm for all subjects in both groups at the completion of treatment). Each subject in the vibration group was treated with exemplary device 100 daily with 120 Hz vibration for five minutes per day, while wearing their current aligner and biting on mouthpiece 102. Subjects in the vibration group changed aligners every five days, while subjects in the control group changed aligners every 14 days. To ensure comparability of selected cases, the vibration group was compared to the control group with the baseline ABO Discrepancy index measurements obtained using intra-oral digital 3D measurements, and analyzed using OrthoCad™ version 4.0.4.403 digital model analyzer for each case. The number of aligners prescribed and used, the aligner change interval, treatment duration, and number of refinements were determined for each subject, and averages and standard deviations for each measure were calculated. These values are illustrated in FIGS. 3A-3C.

FIG. 3A depicts the average number of aligners prescribed and the average number of aligners actually used in the vibration group and in the control group. The numbers prescribed were 25.63±5.78 and 29.38±6.00 for the vibration group and the control group, respectively, which are not significantly different. However, the numbers actually used were 25.63±5.78 and 45.00±10.18 for the vibration group and the control group, respectively, which are significantly different. Thus, every vibration subject achieved end treatment using the originally planned number of aligners, while the control subjects required significantly more aligners than planned to achieve end treatment.

FIG. 3B depicts the average estimated and actual treatment durations for vibration group subjects and control group subjects. For the vibration group, the estimated duration was 51.25 weeks±11.56 weeks, while the actual duration was significantly lower, 19.25 weeks±3.88 weeks. Additionally, the prescribed aligner change interval for the vibration group was 14 days for all subjects. However, the actual aligner change interval was 5 days for seven vibration subjects and 3 days for one vibration subject. This reduced change interval may contribute to the significantly shortened treatment duration since, as noted above for FIG. 3A, the vibration subjects used the same number of aligners in practice as was prescribed.

In contrast, for the control group, the estimated duration was 58.75 weeks±12.00 weeks, which is not significantly different from the estimated duration for the vibration group. However, the actual duration for the control group was significantly higher, 96.75 weeks±18.76 weeks, which differed significantly from the average actual duration of the vibration group. The prescribed and actual aligner change interval for the control group was 14 days. Therefore, the significantly increased number of aligners may contribute to the extended treatment duration.

FIG. 3C depicts the number of refinements required for the vibration and control groups, while Table 1 below summarizes the numbers of aligners and the refinement numbers. “Refinement” refers to a process in which the subject may require one or more additional aligners due to a modification to their treatment plan during the course of treatment. None of the vibration group subjects required refinement, while five control subjects required one refinement and one control subject required two refinements.

TABLE 1
Aligners prescribed vs aligners required & case refinements

| | Initial Aligners¹ | Total Aligners² | Total |
|---|---|---|---|
| Group | Prescribed (Mean) | Required (Mean) | Refinements |
| Vibration | 26 | 26 | 0 |
| Control | 29 | 45 | 7 |

¹No statistical significance,
²Statistical significance

These findings may suggest that clear aligner treatment duration may be significantly reduced using vibration having a frequency of about 120 Hz for less than about twenty minutes daily, for example for five minutes daily, by reducing one or more of the aligner change interval and the total number of aligners required to complete treatment. The subjects in both groups were initially diagnosed with Class 1 malocclusions and mild to moderate crowding, and all subjects in both groups achieved 0.0 mm upper and lower crowding by completion of treatment. These findings may suggest that while treatment may be accelerated by vibration application, tracking may be maintained, since vibration and control subjects both achieved high quality alignment at the end of treatment. Thus, it would appear that vibration having a frequency of about 120 Hz for less than about twenty minutes daily, for example for five minutes daily, may accelerate tooth movement during aligner treatment without hindering or otherwise affecting the ability of the aligners to achieve tooth alignment.

Exemplary vibration having a frequency of about 120 Hz may provide an improvement over prior, lower-frequency vibration devices such as AcceleDent™. Numerous studies (e.g. Woodhouse, Lela) have concluded that lower-frequency vibration, including the 30 Hz treatment provided by AcceleDent™, does not significantly increase the rate of tooth movement during orthodontic treatment, nor does it reduce orthodontic treatment duration. In stark contrast, application of about 120 Hz vibration less than about twenty minutes daily with exemplary device 100 is demonstrated to significantly increase the rate of tooth movement and to significantly decrease treatment duration.

An additional beneficial consequence of the vibration may include improved seating and fit of the clear aligners. It is imperative that aligners properly fit the teeth and are fully seated upon them, so as to ensure accurate and complete transfer of forces from the aligner to the tooth surface. A common practice among clinicians is to recommend “chewies,” small cylinders made of a spongy plastic-like material which patients with aligners may chew on for few minutes per day to promote seating the aligners. However, chewies may produce undesirable distortion of the aligner, and may be burdensome for patients. The application of vibration having a frequency of about 120 Hz may constitute an improvement over chewies because it may produce dynamic impact forces for improving the aligner fit, thereby optimizing force delivery by the aligners to the teeth. Specifically, the vibration may facilitate simultaneous and complete mandibular and maxillary full arch aligner seating, which may maximize optimal, complete, and continuous forces to the teeth. This improved seating may reduce the time interval required between aligners, since tooth movement may be accelerated by the optimized force delivery from the aligners.

Advantageously, these findings may suggest that accelerating tooth movement during aligner treatment with vibration having a frequency of about 120 Hz for less than about twenty minutes daily may provide more predictable treatment, as the vibration subjects only required the prescribed number of aligners and required fewer refinements than control subjects. Additionally, the significantly reduced treatment duration associated with the vibration may save patients time and money, since fewer office visits, refinement scans, and aligners are needed. This shortened duration may additionally increase patient compliance, since some patients may be more likely to strictly follow a treatment plan when it is shorter.

### EXAMPLE 2

A randomized, single blind, multi-center clinical trial was conducted to evaluate effects of daily, five-minute application of 120 Hz vibration to orthodontic patients undergoing clear plastic aligner treatment. All subjects were diagnosed with Class 1 or mild Class II/III malocclusion needing minor lower incisor alignment. Subjects had at least one lower anterior tooth that required only anteroposterior movement of 1 mm and this anteroposterior movement was not blocked by adjacent teeth. All subjects were treated with Smartrack™ plastic aligners which were programmed with 0.25 mm of anterior-posterior movement on the target incisor.

Table 2 below summarizes the five study groups. Subjects in the “14 days” group were not treated with vibration, and changed their aligners every 14 days. Because a 14 day aligner replacement interval is very common in the field, this group may be considered a control group in some embodiments. Subjects in the “7 days” group were not treated with vibration, and changed their aligners every 7 days. Subjects in the “7 days+Vibration” group were treated with 120 Hz vibration for five minutes daily, and changed their aligners every 7 days. Subjects in the “5 days” group were not treated with vibration, and changed their aligners every 5 days. It should be noted that five subjects were recruited for the “5 days” group and none completed the study due to poor tracking, and the associated poor aligner fit and pain. Finally, subjects in the “5 days+Vibration” group were treated with 120 Hz vibration for five minutes daily, and changed their aligners every 5 days. During the trial, seven subjects were disqualified due to failure to apply vibration as prescribed, failure to wear aligners for a sufficient amount of time daily, or failure to change aligners at the required intervals.

TABLE 2
Status of subject enrollment showing number of subjects recruited and
studies completed.

| | Subjects | |
|---|---|---|
| Group | Recruited | Completed Studies |
| 14 days | 15 | 13 |
| 7 days | 15 | 13 |
| 7 days + Vibration | 15 | 14 |
| 5 days | 5 | 0 |
| | | (discontinued due to non-tracking**) |
| 5 days + Vibration | 15 | 13 |
| Total subjects | 65 | 53 |

**Non-tracking refers to actual tooth movement lagging when compared to the digital prediction. As a result, aligner changes were not possible due to improper fit.

Subjects who were treated with vibration (“7 days+Vibration” and “5 days+Vibration”) bit down onto mouthpiece 102 while wearing the current aligner and activated motor 106 for five minutes daily before sleeping. Subjects who were not treated with vibration (“14 days,” “7 days,” and “5 days”) bit on mouthpiece 102 for at least five minutes daily without activating motor 106, or for the longest time which the aligner could be comfortably worn in the mouth without removal. Except for the subjects in the “5 days” group, all subjects received aligner treatment until treatment was finalized (that is, the subjects wore every aligner in their plurality for the required treatment intervals). The time intervals between changing aligners and the total treatment time were calculated for each subject. Additionally, intraoral photographs and digital intraoral scans were taken of each subject at the beginning and conclusion of treatment to evaluate tracking, and subjects completed a pain assessment. A Cadent iTero™ digital scanner was utilized to perform intraoral scanning, and digital scan data was processed with Invisalign ClinCheck 3.0 software to evaluate tracking.

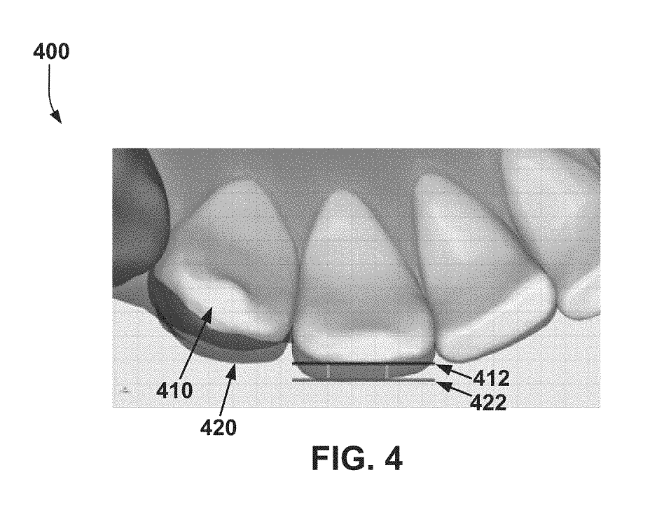

FIG. 4 illustrates an intraoral scan 400 taken from a subject at the end of treatment to evaluate tracking. Scan 400 includes an image 410 of the predicted tooth position at the end of treatment superimposed on an image 420 of the actual tooth position at the end of treatment. The predicted tooth position was generated in accordance with the treatment plan. Line 412 was drawn tangential to the labial surface of the actual position of each tooth, while line 422 was drawn tangential to the labial surface of the predicted position of each tooth. Contact points between tangent lines 412, 422 and respective labial surface of the tooth at both the mesial and distal were marked. The distance between marked points and the counterpart points in the prediction image were measured, and the average of these two numbers was used to measure the percentage tooth movement in comparison with the predicted movement. Percentage tooth movement data was generated for each subject at the end of treatment, with the exception of the “5 days” subjects, who did not complete treatment. Mean and standard deviation were tabulated for each group.

Table 3 below summarizes the tracking percentage for subjects in each experimental group, as well as the p-value for each group. The Control group (“14 days”) demonstrated 84% of predicted tooth movement. The “7 days” group demonstrated even lower tracking of 70%, which was statistically significant compared with the Control group. However, when patients changed aligners every 7 days and received vibration (“7 days+Vibration”), tracking improved significantly compared with the “7 days” group, but was not significantly higher than the Control group. When the interval between aligners was reduced to 5 days (“5 days”), teeth did not move according to the prediction, and progress in treatment was not possible due to poor aligner fitting when attempting to change to the second and third aligners (i.e. poor

TABLE 3
Percentage of tracking in each group

| | Tracking Percentage | |
|---|---|---|
| Group | (Mean ± Standard Deviation) | P |
| 14 days | 84 ± 13* | 0.022 |
| 7 days | 70 ± 16 | N/A |
| 7 days + Vibration | 90 ± 14* | 0.003 |
| 5 days | N/A | N/A |
| 5 days + Vibration | 84 ± 12* | 0.022 |

*Statistically significant differences compared with the “7 days” group

tracking). Therefore, for patient's benefit, their participation in the trial was suspended. However, when the 5 days group received vibration (“5 days+Vibration”), improved tracking was observed which was statically higher than the “7 days” group, but was not statistically different from the Control or “7 days+Vibration” groups.

Table 4 below summarizes pain intensity data as reported by the subjects on the first and third days of aligner treatment. Subjects reported their oral pain and discomfort using a numerical rating scale. The average and standard deviation for pain rating was calculated for each experimental group on the first and third days. There was a statistically significant decrease in reported pain and discomfort between the first day of treatment in the “7 days+Vibration” group in comparison with the “7 days” group and the Control group. No significant differences between the rest of the groups on the first day of aligner wear was observed. On the third day of aligner wear, the “7 days+Vibration” group reported lower pain and discomfort levels compared with the “7 days” group, which was statistically significant. No difference among the rest of the groups was observed on the third day.

TABLE 4
Reported pain and discomfort (Mean ± Standard Deviation)

| Group | First Day Pain Intensity | Third Day Pain Intensity |
|---|---|---|
| 14 days | 4.19 ± 0.71 | 2.42 ± 0.64 |
| 7 days | 4.6 ± 1.13 | 2.98 ± 1.18 |
| 7 days + Vibration | 3.39 ± 1.35*^{#} | 1.96 ± 0.9^{&} |
| 5 days | N/A | N/A |
| 5 days + Vibration | 3.7 ± 0.95 | 2.21 ± 0.91 |

*Statistically significant difference compared with first day of “7 days” group (p < 0.020)
^{#}Statistically significant difference compared with first day of “14 days” group (p < 0.034)
^{&}Statistically significant difference compared with third day of “7 days” group (p < 0.026)

As described above, steps have been taken in the field to improve the efficiency of force delivery by aligners. For example, the construction of aligners using Smartrack™ plastic has improved the efficiency of force application by aligners, as suggested by the 84% tracking percentage demonstrated by the Control group. However, the biological response has previously prevented the shortening of aligner changing intervals. For example, if the rate of tooth movement continues to be slow, then it is not possible for the interval between aligner changings to be shortened without increasing the risk of non-tracking. Previously, studies have demonstrated that the rate of tooth movement (e.g. due to the application of tension by orthodontic appliances such as aligners) depends on cytokine activation, which can stimulate osteoclasts and increase bone resorption, thus allowing for tooth movement. Additionally, studies have shown that the rate of cytokine activation and bone resorption does not always increase linearly with the magnitude of force applied to the teeth, but instead shows a biological “saturation point” beyond which a large force magnitude will not increase the rate of tooth movement. Thus, these studies suggest that attempts to decrease the interval between aligner changing will not necessarily increase the rate of tooth movement. This suggestion may be supported by the experimental findings for the “7 days” group, which demonstrated a decreased tooth movement of only 71% of planned movement. In some cases, lack of tracking may accumulate from one aligner to the next, and may be accompanied by a significant discrepancy from predicted tooth movement.

The findings of Example 2 may demonstrate that use of vibration having a frequency of about 120 Hz for less than about twenty minutes per day, for example for five minutes per day, may decrease the aligner changing interval from 14 days to 5 or 7 days without affecting the quality of tracking. In fact, 7 day intervals with vibration produced slightly better results than 14 day intervals without vibration, although the difference was not statistically significant. These reduced changing intervals may reduce the overall treatment time, since the number of aligners utilized by the subjects was unchanged by vibration. In the exemplary application of the treatment of the present disclosure, treatment time was decreased by about 50%.

The study by Alikhani et al. demonstrated that high frequency vibration in rats is associated with increased rates of bone formation. The authors suggest that this effect may be associated, at least in part, with increased osteoblast activity. Therefore, it is hypothesized here that high frequency vibration delivered by exemplary device 100 may accelerate tooth movement by controlling the patient's biological response to force application by the aligners. By increasing the rate of cytokine activation and chemokine levels, exemplary device 100 may facilitate activation of osteoclasts, which may then increase the rate of bone resorption and accelerate tooth movement.

Additionally, the findings of Example 2 may suggest that high frequency vibration delivered by exemplary device 100 may reduce the pain and discomfort associated with aligner treatment during the first three days of aligner treatment. These findings are in agreement with those of Alikhani, which suggests that high frequency vibration may alter the metabolism and proliferation of the periodontal ligament cells without increasing pain or discomfort. Vibration having a frequency of about 120 Hz delivered by exemplary device 100 may provide pain-relieving effects at least in part by increasing vascularity in the mouth and reducing areas of ischemia, and through activation of large-diameter sensory nerve fibers. Advantageously, this may make aligner treatment a more attractive option for patients, and may increase rates of patient compliance.

### EXAMPLE 3

A simulation was conducted to test and compare the vibration characteristics of a typodont caused by exemplary vibrational dental device 100 and a commercially available dental device, the AcceleDent Aura™, developed by OrthoAccel® Technologies, Inc. In the simulation setup, the typodont was secured to a metal table. The upper jaw of the typodont was hinged to the lower jaw and capable of opening and closing. Each device was placed in the typodont (between the occlusal surfaces) and held in position by securely mounting a weight of about 0 to 4 pounds on the upper jaw. The weight simulates the biting force typically applied by a user to clamp the devices in place.

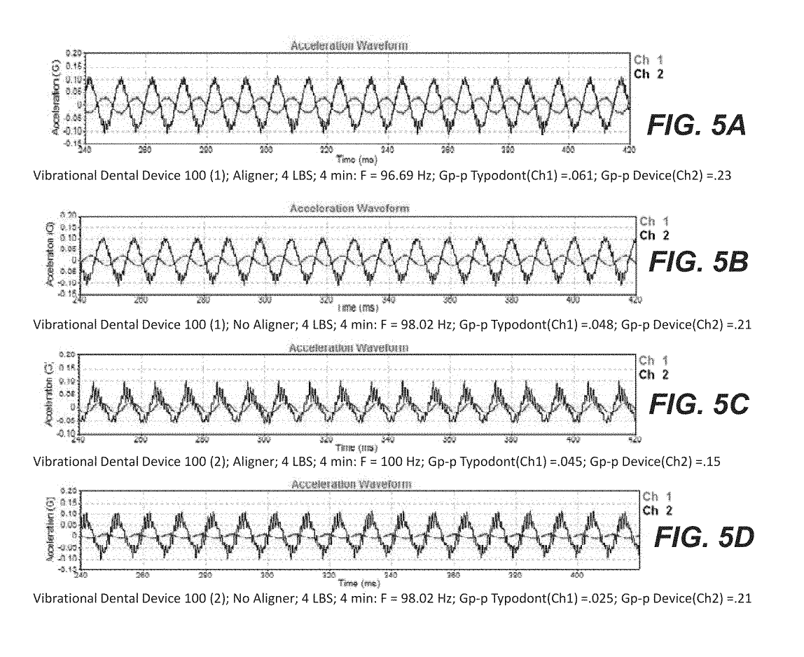

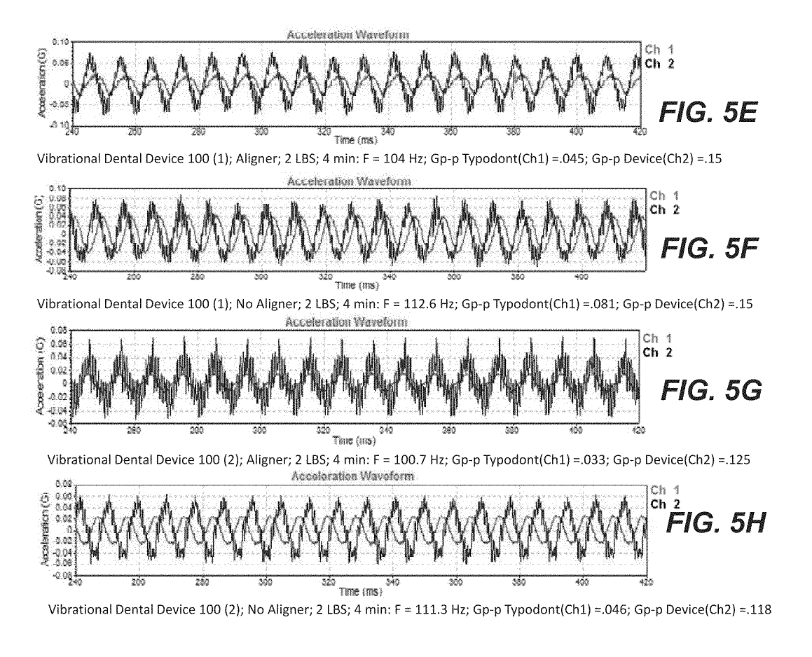

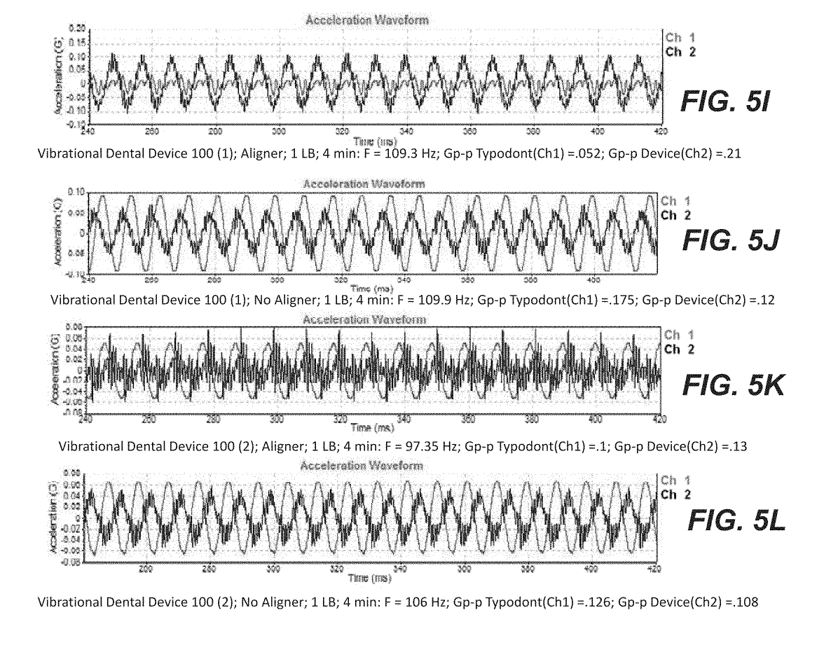

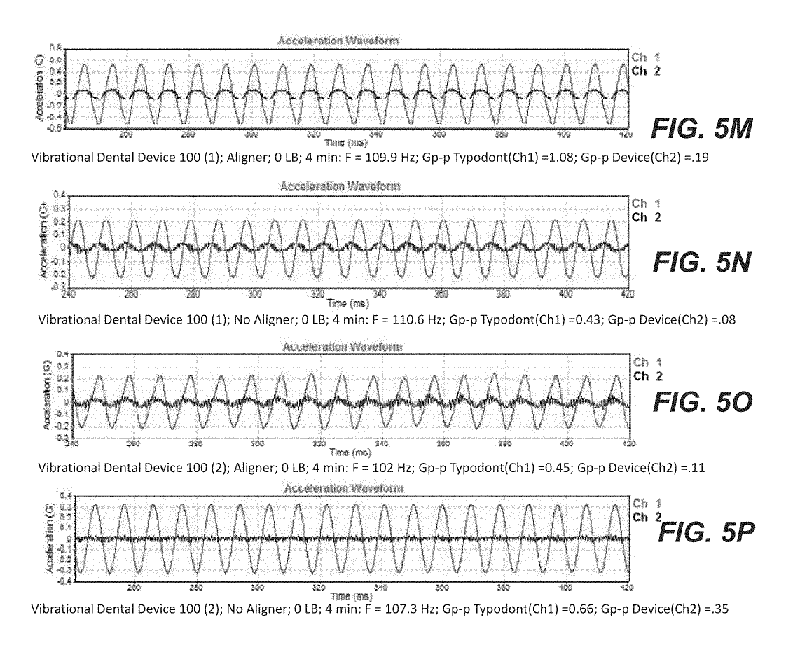

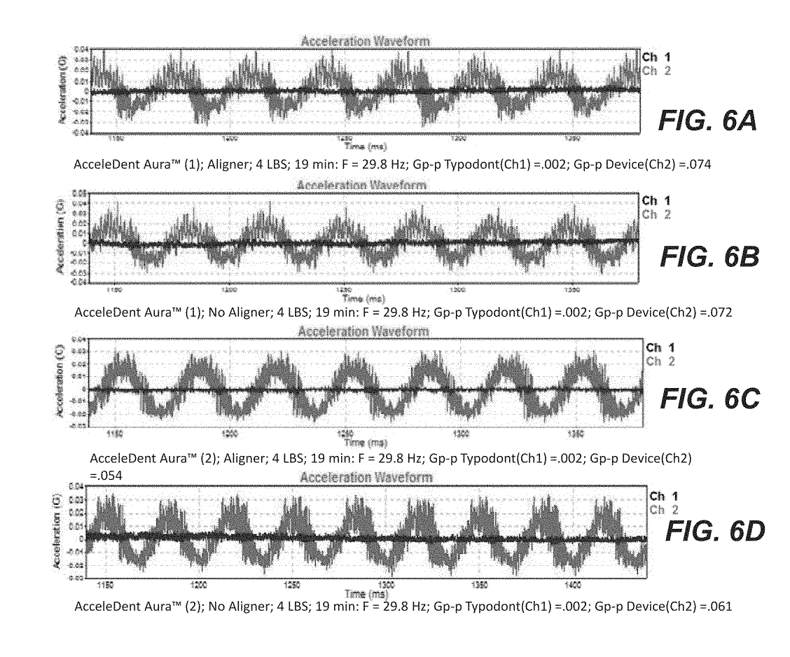

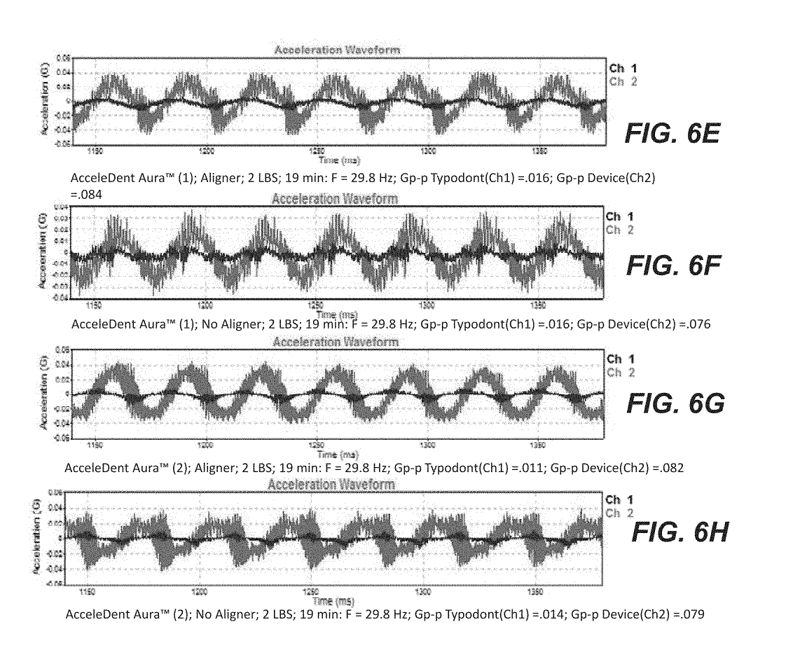

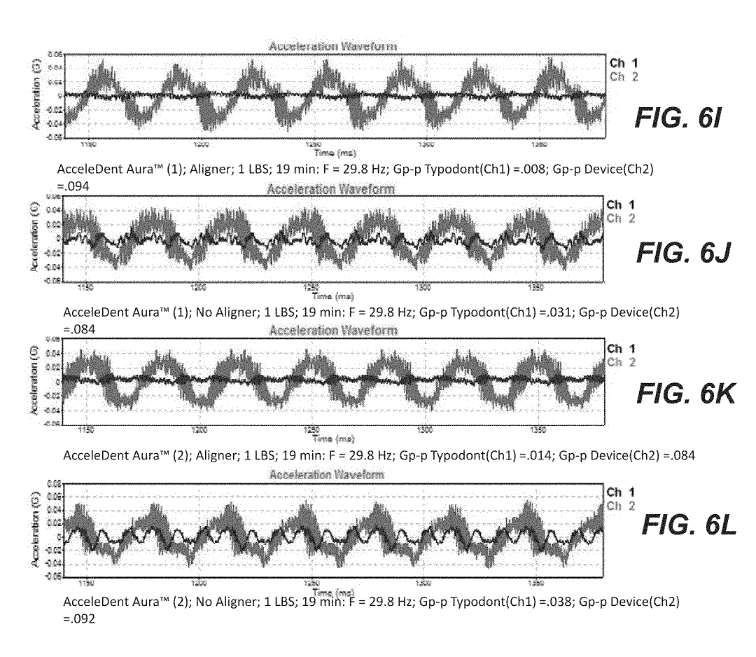

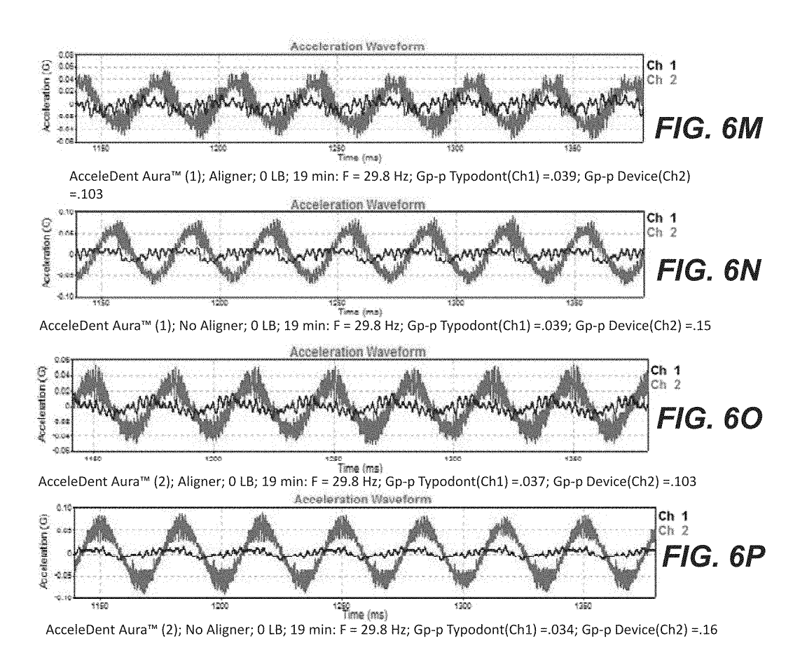

The simulation setup further included electronic instruments, including accelerometers, for measuring vibration characteristics of the typodont. The accelerometers were placed directly on the devices and on the typodont. FIGS. 5A-6P each show the measurement dataset of the accelerometer for two channels, channel 1 (“Ch1”) for detecting the vibration characteristics of the typodont and channel 2 (“Ch2”) for detecting the vibration characteristics of the device. As shown in FIGS. 5A-6P, measurements of the accelerometers over the operation time of each device recorded increasing and decreasing accelerations of the devices and the typodont. The measurement dataset of the accelerometers resembles a sinusoidal curve. The distance from the bottom to the top of the sinusoidal curve is called the peak-to-peak G value or g-force (Gₚ₋ₚ).

In this simulation, the operation time of exemplary vibrational dental device 100 was 5 minutes. The operation time of AcceleDent Aura™ was 20 minutes. The maximum Gₚ₋ₚ values of the vibration of the typodont actuated by these two devices under different simulated biting forces (different weights) were measured using the accelerometers and other associated electronic instruments one minute before the end of the operation time. Therefore, measurement of the frequency and g-force for each channel was performed at the time point of 4 minutes for exemplary vibrational dental device 100 and at the time point of 19 minutes for AcceleDent Aura™.

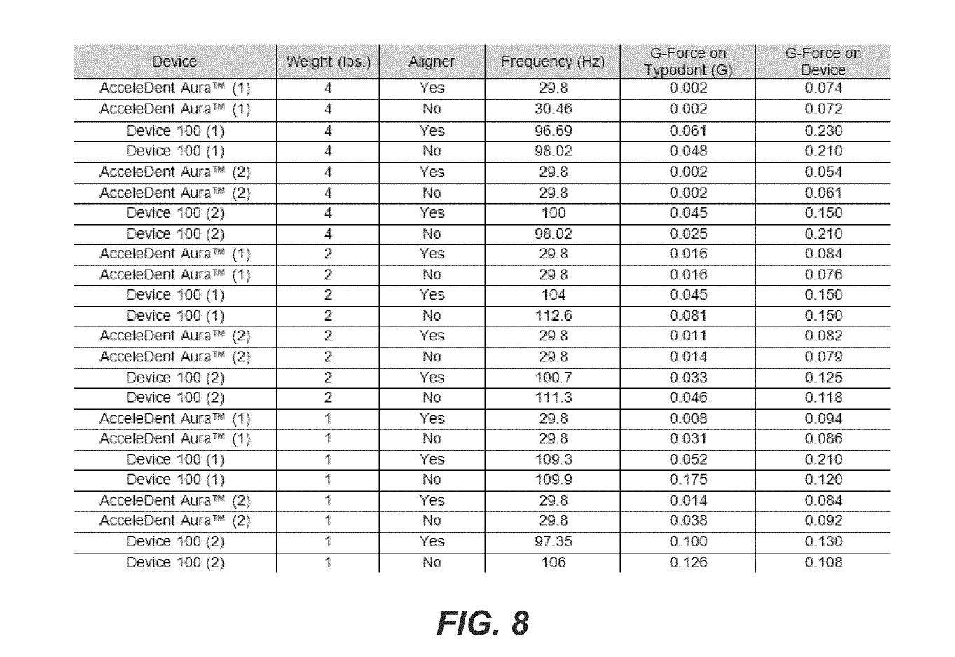

The simulation was repeated for a second testing device of exemplary vibrational dental device 100 and a second testing device of AcceleDent Aura™. Therefore, the exemplary first and second vibration dental devices 100 tested are shown as exemplary vibrational dental device 100 (1) and exemplary vibrational dental device 100 (2) respectively in FIGS. 5A-5P. Also, the first and second AcceleDent Aura™ devices are shown as AcceleDent Aura™ (1) and AcceleDent Aura™ (2) respectively in FIGS. 6A-6P. The simulation was also repeated where the typodont was installed with and without an aligner, as indicated in the captions of FIGS. 5A-5P. All measurement data was summarized in FIG. 8.

In exemplary embodiments, the exemplary vibrational dental device 100 can be configured to deliver g-forces above those found in prior art devices indicated for use with aligners.

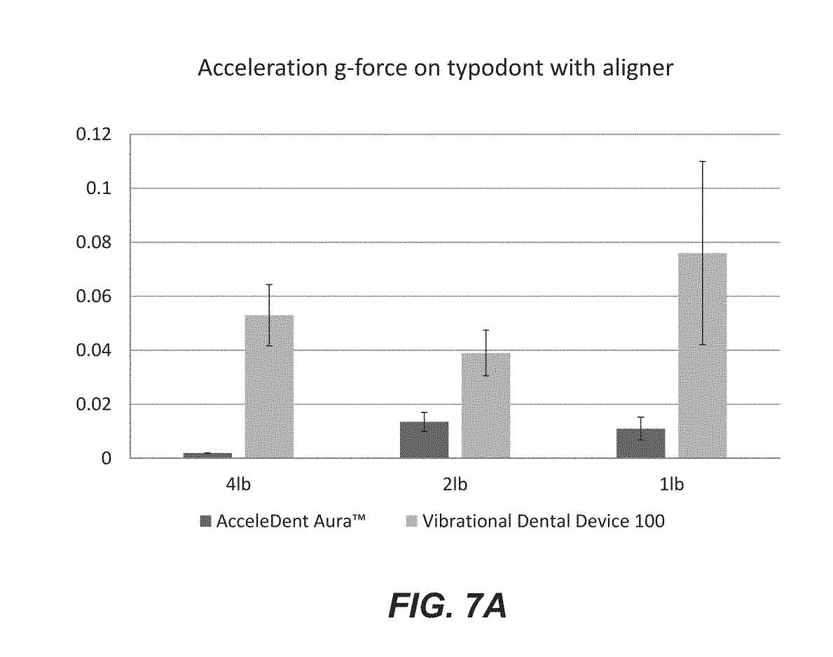

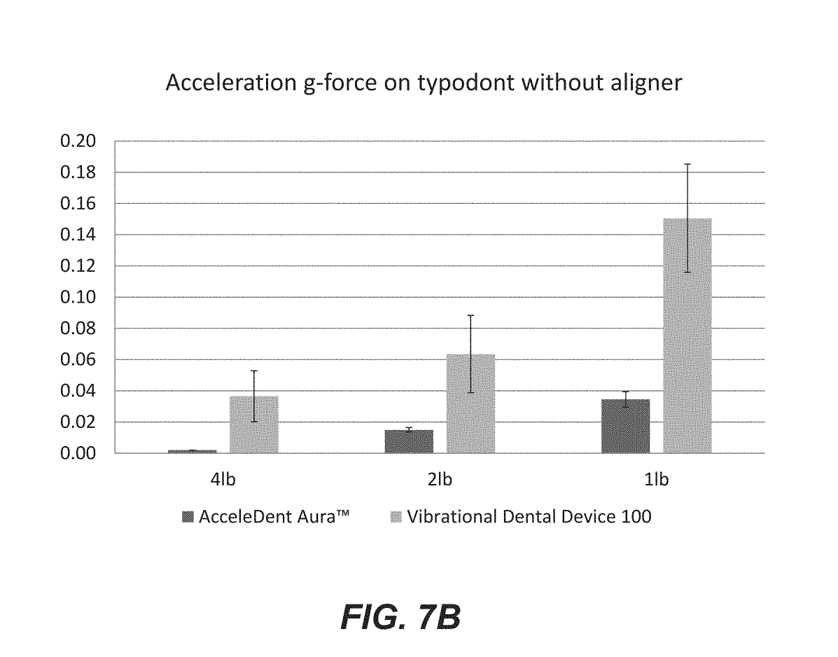

FIG. 7A and Table 5 below show the measured g-force values (Gₚ₋ₚ) of the typodont mounted with different weights while subject to vibration by an exemplary embodiment of vibrational dental device 100 and by the AcceleDent Aura™ with the aligner. FIG. 7B and Table 6 below show the measured g-force values (Gₚ₋ₚ) of the typodont mounted with different weights while subject to vibration by exemplary vibrational dental device 100 and by the AcceleDent Aura™ without the aligner. As described herein, results shown in FIGS. 7A and 7B and Tables 5 and 6 were average values and standard deviations of the measured g-force values (Gₚ₋ₚ) on the typodont caused by the two testing devices of exemplary vibrational dental device 100 and the two testing devices of AcceleDent Aura™.

TABLE 5
Average g-force values (Gₚ₋ₚ) of the typodont mounted with different
weights while subject to vibration by vibrational dental device
100 and by the AcceleDent Aura ™ with the aligner.

| | 4 lbs. | | 2 lbs. | | 1 lbs. | |
|---|---|---|---|---|---|---|
| Device | Average | SD | Average | SD | Average | SD |
| AcceleDent | 0.002 | 0.0000 | 0.0135 | 0.0035 | 0.011 | 0.0042 |
| Aura ™ | | | | | | |
| Device 100 | 0.053 | 0.0113 | 0.0390 | 0.0085 | 0.076 | 0.0339 |

TABLE 6
Average g-force values (Gₚ₋ₚ) of the typodont mounted with different
weights while subject to vibration by vibrational dental device
100 and by the AcceleDent Aura ™ without the aligner.

| | 4 lbs. | | 2 lbs. | | 1 lbs. | |
|---|---|---|---|---|---|---|
| Device | Average | SD | Average | SD | Average | SD |
| AcceleDent | 0.0020 | 0.0000 | 0.0150 | 0.0014 | 0.0345 | 0.0049 |
| Aura ™ | | | | | | |
| Device 100 | 0.0365 | 0.0163 | 0.0635 | 0.0247 | 0.1505 | 0.0346 |

As shown in FIGS. 7A and 7B, exemplary vibrational dental device 100 produced greater acceleration than the AcceleDent Aura™ at various simulated biting forces (under various weights). When the typodont was fitted an aligner (as shown in FIG. 7A and Table 5), depending on the simulated biting force, the AcceleDent Aura™ caused very low acceleration levels of the typodont with g-force values from less than 0.01 G to no greater than 0.02 G. In contrast, exemplary vibrational dental device 100 resulted in higher acceleration levels of the typodont with g-force values ranging from about 0.04 G to about 0.076 G. In particular, the two-pound and four-pound weights (or simulated biting force) caused the AcceleDent Aura™'s measured average g-force values to drop to very low levels of 0.0135 G and 0.002 G, respectively. When the typodont was without an aligner (as shown in FIG. 7B and Table 6), depending on the simulated biting force, the AcceleDent Aura™ similarly caused very low acceleration levels with g-force values from less than 0.01 G to no greater than 0.04 G. Again, in contrast, exemplary vibrational dental device 100 resulted in multi-fold higher acceleration levels with g-force values ranging from about 0.04 G to about 0.15 G. These results suggest that exemplary vibrational dental device 100 can produce greater acceleration magnitude of the typodont under different simulated biting forces than the AcceleDent Aura™ with or without aligners.

### EXAMPLE 4

A prospective study was conducted to evaluate root resorption in vibrational dental devices as compared to controls. Root resorption is a process by which the body's cells breakdown and destroy the root structure of a tooth. Root resorption has been demonstrated to occur when large forces are applied to teeth, such as during orthodontic treatment. In particular, root resorption is increased by attempts to move teeth too quickly during aligner treatment, such as during treatment in which aligners are changed too quickly. In the study of Example 4, subjects undergoing clear aligner treatment were treated with vibration to evaluate the effects of vibration on root resorption.

In this study, thirty subjects with class I malocclusion with an initial ABO (American Board of Orthodontics) discrepancy index of 12±10 were recruited. All subjects were treated with Smartrack™ clear aligners. Ten subjects were treated with 120 Hz vibration with exemplary device 100 for five minutes daily. Ten subjects were treated with 30 Hz vibration with an AcceleDent™ device for 20 minutes daily. Ten subjects did not receive any mechanical treatment to serve as a control group. All subjects reported and changed aligners when their current aligner became loose at the anterior and posterior parts in both ides. The aligner change intervals were recorded for all patients. Additionally, cone beam computed tomography CBCT) scans were taken for all patients before aligner treatment began (T1) and after the completion of aligner treatment (T2).

To compensate for any angulation of the incisors in the CBCT scans, the upper incisor lengths were measured using a 3D Cartesian coordinate system. The root apex and the middle of the incisal border of each maxillary incisor were identified in the axial, sagittal, and coronal sections. The 3D coordinates of each point were obtained, and the distance between the apex and the border of the incisal edge was calculated using the formula:

D={square root over (((X_{C}−X_{R})²+(Y_{C}−Y_{R})²+(Z_{C}−Z_{R})²))}

where D is the tooth length, X is the transversal position (relation to X-axis), Y is the anteroposterior position (relation to Y-axis), Z is the vertical position (relation to X-axis), C is the point on the incisal edge, and R is the point root apex. Root resorption was calculated by assessing the difference in the total root length between T1 and T2. Maxillary incisors were selected for the evaluation of root resorption because these teeth have been found to be affected by resorption more than other teeth in the mouth.

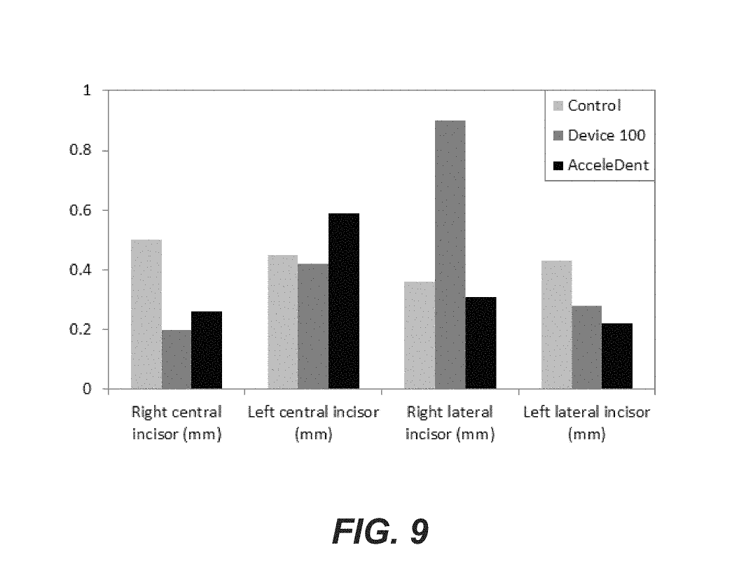

The findings of Example 4 are summarized in Table 7 below and illustrated in FIG. 9. The control group showed statistically significant root resorption in all four measured teeth. The AcceleDent™ group demonstrated non-statically significant root resorption in all measured teeth. The exemplary device 100 group demonstrated non-statistically significant root resorption in the right central incisor, left lateral incisor, and right lateral incisor, and statistically significant root resorption in the left lateral incisor. When comparing the measured root resorption between the three groups (intergroup comparison), no statistically significant difference was found (p=0.007).

TABLE 7
Measured tooth movement between T1 (beginning of aligner treatment) and T2 (completion
of aligner treatment) for control group, AcceleDent ™ group, and Device 100 group

| | Right central Incisor | | Left central Incisor | | Right lateral Incisor | | Left lateral Incisor | |
|---|---|---|---|---|---|---|---|---|
| Device | Avg. (mm) | P | Avg. (mm) | P | Avg. (mm) | P | Avg. (mm) | P |
| Control | 0.5 | 0.0014 | 0.45 | 0.001 | 0.36 | 0.0019 | 0.43 | 0.0003 |
| (No Vibration) | | | | | | | | |
| AcceleDent ™ | 0.2 | 0.08 | 0.42 | 0.1 | 0.9 | 0.12 | 0.28 | 0.008 |
| Device 100 | 0.26 | 0.45 | 0.259 | 0.34 | 0.31 | 0.39 | 0.22 | 0.37 |

These findings suggest that either high or low frequency vibration of the teeth during clear aligner treatment may result in significantly less root resorption as compared to patients undergoing clear aligner treatment alone. It is hypothesized that the vibration may be associated with improved cellular and molecular response of the alveolar bone, which may reduce root resorption. These findings also suggest a non-statistically significant difference between root resorption in the high and low frequency vibration groups. Given the numerous advantages of high frequency vibration demonstrated above in Examples 1-3, these findings suggest that high frequency vibration may provide the additional benefit of reducing root resorption during clear aligner treatment. This is especially significant given the risks associated with accelerated tooth movement without vibration application. Therefore, these findings may suggest that vibration having a frequency of about 120 Hz may not only accelerate tooth movement during clear aligner treatment while maintaining quality tracking, but that the vibration may additionally reduce root resorption that may otherwise occur during aligner treatment, especially without vibration application.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for accelerating an orthodontic treatment which includes a plurality of aligners, the method comprising:
obtaining the aligners, wherein the aligners are configured to be worn in the mouth of a patient in a pre-determined sequence to move the patient's teeth substantially into a desired alignment;
obtaining an orthodontic movement acceleration device, the device comprising:
a mouthpiece, and
a vibration source coupled to the mouthpiece and configured to vibrate at a frequency of about 120 Hz; and
treating the teeth with each aligner in the pre-determined sequence, wherein for each aligner treatment includes
placing the mouthpiece within the mouth of the patient while the patient is wearing the aligner, and
activating the vibration source for about five minutes daily while the aligner contacts the mouthpiece, wherein the activation of the vibration source accelerates movement of the teeth substantially into the desired alignment.

2. The method of claim 1, wherein the teeth are treated with each aligner for a treatment duration of between about five days and about seven days.

3. The method of claim 1, wherein at least one aligner is configured for about 0.25 mm movement of a target tooth.

4. The method of claim 1, wherein the aligners are configured based upon a pre-determined treatment plan for the patient, the treatment plan including a predicted tooth movement trajectory, and wherein treatment of the teeth with the orthodontic movement acceleration device does not increase a difference between the predicted tooth movement trajectory and an actual tooth movement trajectory.

5. The method of claim 1, further comprising treating the teeth with each aligner in the pre-determined sequence until the teeth are substantially in the desired alignment.

6. The method of claim 1, wherein treatment of the teeth with the orthodontic movement acceleration device reduces a treatment time of the orthodontic treatment by at least about 50%.

7. A method for accelerating an orthodontic treatment which includes a plurality of aligners, the method comprising:
obtaining the aligners, wherein the aligners are configured to be worn in the mouth of a patient in a pre-determined sequence to move the patient's teeth substantially into a desired alignment;
obtaining an orthodontic movement acceleration device, the device comprising:
a mouthpiece, and
a vibration source coupled to the mouthpiece and configured to vibrate at an acceleration magnitude ranging between about 0.03 G and about 02 G; and
treating the teeth with each aligner in the pre-determined sequence, wherein for each aligner treatment includes
placing the mouthpiece within the mouth of the patient while the patient is wearing the aligner, and
activating the vibration source for about five minutes daily while the aligner contacts the mouthpiece, wherein the activation of the vibration source accelerates movement of the teeth substantially into the desired alignment.

8. The method of claim 7, wherein the teeth are treated with each aligner for a treatment duration of between about five days and about seven days.

9. The method of claim 7, wherein at least one aligner is configured for about 0.25 mm movement of a target tooth.

10. The method of claim 7, wherein the aligners are configured based upon a pre-determined treatment plan for the patient, the treatment plan including a predicted tooth movement trajectory, and wherein treatment of the teeth with the orthodontic movement acceleration device does not increase a difference between the predicted tooth movement trajectory and an actual tooth movement trajectory.

11. The method of claim 7, further comprising treating the teeth with each aligner in the pre-determined sequence until the teeth are substantially in the desired alignment.

12. The method of claim 7, wherein treatment of the teeth with the orthodontic movement acceleration device reduces a treatment time of the orthodontic treatment by at least about 50%.

13. A method for accelerating orthodontic treatment by minimizing a treatment duration associated with at least one aligner in a plurality of aligners, wherein the aligners are configured to be worn in the mouth of a patient in a pre-determined sequence to move the patient's teeth substantially into a desired alignment, the method comprising:
treating the teeth with the aligners in the pre-determined sequence, wherein the teeth are treated with each aligner for a treatment duration; and
for at least one aligner, accelerating teeth movement by:
applying vibration to the aligner for about five minutes daily with a vibration device while the patient is wearing the aligner, wherein the vibration device is configured to vibrate with a frequency of about 120 Hz,
wherein the vibration accelerates teeth movement such that the treatment duration for the at least one aligner is about 7 days or fewer.

14. The method of claim 13, wherein at least one aligner is configured for about 0.25 mm movement of a target tooth.

15. The method of claim 13, wherein the aligners are configured based upon a pre-determined treatment plan for the patient, the treatment plan including a predicted tooth movement trajectory, and wherein acceleration of teeth movement by the vibration device does not increase a difference between the predicted tooth movement trajectory and an actual tooth movement trajectory.

16. The method of claim 13, further comprising treating the teeth with each aligner in the pre-determined sequence until the teeth are substantially in the desired alignment.

17. The method of claim 13, wherein acceleration of teeth movement by the vibration device reduces a treatment time of the orthodontic treatment by at least about 50%.

18. The method of claim 13, wherein acceleration of teeth movement by the vibration device accelerates movement of the teeth substantially into the desired alignment.

19. A method for accelerating orthodontic treatment by minimizing a treatment duration associated with at least one aligner in a plurality of aligners, wherein the aligners are configured to be worn in the mouth of a patient in a pre-determined sequence to move the patient's teeth substantially into a desired alignment, the method comprising:
treating the teeth with the aligners in the pre-determined sequence, wherein the teeth are treated with each aligner for a treatment duration; and
for at least one aligner, accelerating teeth movement by:
applying vibration to the aligner for about five minutes daily with a vibration device while the patient is wearing the aligner, wherein the vibration device is configured to vibrate at an acceleration magnitude ranging between about 0.03 G and about 0.2 G,
wherein the vibration accelerates teeth movement such that the treatment duration for the at least one aligner is 7 days or fewer.

20. The method of claim 19, wherein at least one aligner is configured for about 0.25 mm movement of a target tooth.

21. The method of claim 19, wherein the aligners are configured based upon a pre-determined treatment plan for the patient, the treatment plan including a predicted tooth movement trajectory, and wherein acceleration of teeth movement by the vibration device does not increase a difference between the predicted tooth movement trajectory and an actual tooth movement trajectory.

22. The method of claim 19, further comprising treating the teeth with each aligner in the pre-determined sequence until the teeth are substantially in the desired alignment.

23. The method of claim 19, wherein acceleration of teeth movement by the vibration device reduces a treatment time of the orthodontic treatment by at least about 50%.

24. The method of claim 19, wherein acceleration of teeth movement by the vibration device accelerates movement of the teeth substantially into the desired alignment.

25. A method for improving the fit of at least one aligner for orthodontic treatment, the method comprising:
obtaining a number of aligners, wherein the aligners are configured to be worn in the mouth of a patient in a pre-determined sequence and wherein the aligners are fabricated according to a treatment plan for the patient to move the patient's teeth substantially into a desired alignment; and
treating the teeth with the aligners in the pre-determined sequence and, for at least one aligner, improving the fit thereof by:
applying vibration to the aligner for about five minutes daily with a vibration device while the patient is wearing the aligner, wherein the vibration device is configured to vibrate with a frequency of about 120 Hz,
wherein the vibration improves the fit of the at least one aligner upon the teeth such that movement of the teeth due to the aligner is accelerated.

26. The method of claim 25, wherein the teeth are treated with each aligner for a treatment duration of between about five days and about seven days.

27. The method of claim 25, wherein at east one aligner is configured for about 0.25 mm movement of a target tooth.

28. The method of claim 25, wherein the treatment plan includes a predicted tooth movement trajectory, and wherein improvement of the aligner fit by the vibration device does not increase a difference between the predicted tooth movement trajectory and an actual tooth movement trajectory.

29. The method of claim 25, further comprising treating the teeth with each aligner in the pre-determined sequence until the teeth are substantially in the desired alignment.

30. The method of claim 25, wherein improvement of the aligner fit by the vibration device reduces a treatment time of the orthodontic treatment by at least about 50%.

31. A method for improving the fit of at east one aligner for orthodontic treatment, the method comprising:
obtaining a number of aligners, wherein the aligners are configured to be worn in the mouth of a patient in a pre-determined sequence and wherein the aligners are fabricated according to a treatment plan for the patient to move the patient's teeth substantially into a desired alignment; and
treating the teeth with the aligners in the pre-determined sequence and, for at least one aligner, improving the fit thereof by:
applying vibration to the aligner for about five minutes daily with a vibration device while the patient is wearing the aligner, wherein the vibration device is configured to vibrate at an acceleration magnitude ranging between about 0,03 G and about 0.2 G,
wherein the vibration improves the fit of the at least one aligner upon the teeth such that movement of the teeth due to the aligner is accelerated.

32. The method of claim 31, wherein the teeth are treated with each aligner for a treatment duration of between about five days and about seven days.

33. The method of claim 31, wherein at least one aligner is configured for about 0.25 mm movement of a target tooth.

34. The method of claim 31, wherein the treatment plan includes a predicted tooth movement trajectory, and wherein improvement of the aligner fit by the vibration device does not increase a difference between the predicted tooth movement trajectory and an actual tooth movement trajectory.

35. The method of claim 31, further comprising treating the teeth with each aligner in the pre-determined sequence until the teeth are substantially in the desired alignment.

36. The method of claim 31, wherein improvement of the aligner fit by the vibration device reduces a treatment time of the orthodontic treatment by at least about 50%.
